(19) United States
(12) Patent Application Publication
(10) Pub. No.: US 2014/0050099 A1
(43) Pub. Date: Feb. 20, 2014

(54) Network Device and Method for Loop Detection

(71) Applicants: Chi-Feng Lin, Hsinchu City (TW); Yi-Hung Chen, Hsinchu City (TW)

(72) Inventors: Chi-Feng Lin, Hsinchu City (TW); Yi-Hung Chen, Hsinchu City (TW)

(21) Appl. No.: 13/590,162

(22) Filed: Aug. 20, 2012

(51) Int. Cl. H04L 12/26

(52) U.S. Cl. 370/241

(57) ABSTRACT

A network device for loop detection in a network environment, which includes a broadcast frame detection unit for detecting a broadcast storm condition, a loop detection frame generation unit for generating and transmitting a loop detection frame if the broadcast storm condition detected by the broadcast frame detection unit indicates a broadcast storm happens, a frame parser unit for parsing a network frame received by the network device to obtain an information from the network frame, and a loop checking unit for comparing the network frame with the loop detection frame based on the information obtained from the network frame.

### BACKGROUND

The present invention relates to a network device and method for loop detection, and more particularly, to a network device and method that can provide loop detection of a network environment by reusing existing units, such that the hardware cost and effort can be reduced.

A loop in a network environment may cause the network become unusable or inefficient. If a network device can transmit a frame to one another network device via two or more paths, the paths between the two devices may form a loop in the network environment. In such a condition, broadcast frames will be transmitted repeatedly in the loop, causing starvation of the network resource and bandwidth.

One known protocol for resolving loop problem is spanning tree protocol (STP). The main purpose of STP is to ensure loop-free topologies in data networks by blocking redundant paths. The STP has been proven effective in eliminating bridge loops. However, in order to run STP, at least a processor with external memory would be needed. To a dumb switch, hardware cost for enabling STP is too high.

Alternatively, loop problem can be resolved by hardware implementation. For example, US Patent Application Publication No. US 2006/0285499 A1, has disclosed a network device for detecting a loop condition by periodically broadcasting loop detection frames. However, such network device wastes network bandwidth, since the loop detection frames are periodically broadcasted as long as the network device is power-on.

Another approach is to provide a network device for detecting if a source address of a packet received by the network device is moved, as disclosed in US Patent Application Publication No. US 2011/0128863 A1. In detail, when detecting the source address move event, the network device starts sending a loop detection frame to detect a loop condition. However, several new components (e.g. source address move detection unit and random number generation unit) are required for such network device to detect a loop condition, causing hardware cost rises.

### SUMMARY

It is therefore a primary objective of the present invention to provide a network device and method for loop detection, which provides loop detection of a network environment by reusing existing components without additional ones, for reducing hardware cost and of network bandwidth/resource occupation.

The present invention discloses a network device for loop detection in a network environment. The network device includes a broadcast frame detection unit, for detecting a broadcast storm condition; a loop detection frame generation unit, for generating and transmitting a loop detection frame if the broadcast storm condition detected by the broadcast frame detection unit indicates a broadcast storm happens; a frame parser unit, coupled to the broadcast frame detection unit, for parsing a network frame received by the network device to obtain an information from the network frame; and a loop checking unit, coupled to the frame parser unit, for comparing the network frame with the loop detection frame based on the information obtained from the network frame.

The present invention further discloses a method for a network device to perform loop detection in a network environment. The method includes detecting a broadcast storm condition; generating and transmitting a loop detection frame if the broadcast storm is detected to happen; parsing a network frame received by the network device to fetch obtain an information from the network frame; and comparing the network frame with loop detection frame based on the information obtained from the network frame.

The present invention further discloses a network device for loop detection in a network environment. The network device includes a processor, a computer-readable medium and a program code embedded in the computer-readable medium. The program code instructs the processor to execute the following steps: detecting a broadcast storm condition; generating and transmitting a loop detection frame if the broadcast storm condition indicates a broadcast storm happens; parsing a network frame received by the network device to obtain an information from the network frame; and comparing the network frame with the loop detection frame based on the information obtained from the network frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a network device according to a first embodiment of the present invention.

FIG. 2 illustrates a flowchart diagram of a loop detection process of the present invention.

FIG. 3 illustrates a state diagram of the network device of the present invention.

FIG. 4 illustrates a schematic diagram of a network device according to a second embodiment of the present invention.

### DETAILED DESCRIPTION

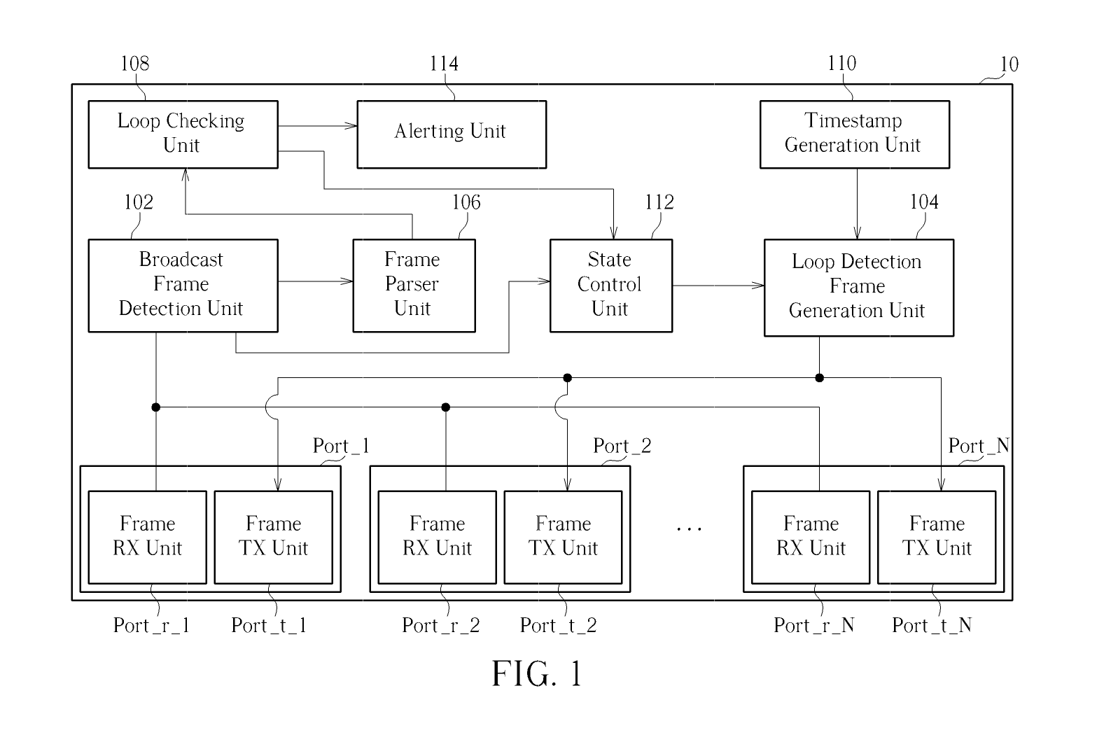

Please refer to FIG. 1, which is a schematic diagram of a network device 10 according to a first embodiment of the present invention. The network device 10 includes a broadcast frame detection unit 102, a loop detection frame generation unit 104, a frame parser unit 106, a loop checking unit 108, a timestamp generation unit 110, a state control unit 112, communication ports Port_1-Port_N and an alerting unit 114.

The broadcast frame detection unit 102 detects broadcast frame reception in the network device 10. If at least one broadcast frame is detected, the broadcast frame detection unit 102 further calculates the broadcast frame rate. When the broadcast frame rate exceeds a broadcast threshold, the loop detection frame generation unit 104 generates and transmits loop detection frames via the communication ports Port_1-Port_N.

The frame parser unit 106 parses network frames from the network environment to obtain information from each network frame. In the present invention, the obtained information may include at least a source address, a destination address, a frame type, an operation code, a module ID, a port ID, a timestamp identification code and padding data. The source address may be a MAC address of a source which transmits the network frame; that is, the source address will be the MAC address of the network device 10 if the network frame is transmitted by the network device 10. Similarly, the destination address may be a MAC address of a destination which receives the network frame. The network frame is broadcast if the destination address conforms to a predefined address, e.g. FFFFFFFFFFFF in hexadecimal form. The frame type remarks the type of the network frame. For the loop detection frame, the frame type may be set by the manufacturer of the network device. The operation code denotes the purpose of the network frame. For the loop detection frame, the operation code may be fixed to be 0001 in hexadecimal form. The module ID is 6-byte user-set ID code of the source network device. The port ID is the port number determined by the source for transmitting the network frame. The timestamp identification code denotes the value of the timestamp counter at the instant that the network frame is transmitted by the network device. Each time when the loop detection frame was transmitted, the timestamp identification code is attached to the loop detection frame and registered for subsequent comparison to the timestamp identification code in the received network frame. The padding data may be filled with all 0s. The loop detection frame includes a source address field, a destination address field, a type field, an operation code field, a module ID field, a port ID field, a timestamp identification code field and a padding field, for carrying such information.

The loop checking unit 108 determines whether a loop exists by comparing the received network frame with the loop detection frame based on the information obtained by the frame parser unit 106. If the received network frame is originally transmitted from the network device 10, i.e. the received network frame is the loop detection frame, the loop checking unit 108 determines a loop exists in the network environment.

The timestamp generation unit 110 is utilized for attaching a timestamp identification code to the loop detection frame. The timestamp identification code may be used for estimating loop size when a loop exists in the network environment. For example, if the difference between the timestamp identification code of the received network frame and the timestamp counter in the timestamp generation unit 110 is 30284 nanoseconds, the loop checking unit 108 keeps the difference as the loop latency. The loop size can be estimated base on the loop latency.

The communication ports Port_1-Port_N are communication bridges between the network device 10 and the network environment. Each of the communication ports Port_1-Port_N may contain a frame transmission unit and a frame reception unit. For example, the communication port Port_1 may contain a frame transmission unit Port_t_1 and a frame reception unit Port_r_1. The frame transmission units Port_t_1-Port_t_N transmit network frames from the network device 10 to the network environment, and the frame transmission units Port_r_1-Port_r_N receive network frames from the network environment.

One main advantage of the network device 10 is that, the broadcast frame detection unit 102 and the timestamp generation unit 110, which are common units in the generic network devices, are used for loop detection in the present invention. No additional broadcast frame detection unit or timestamp generation unit is needed for loop detection.

The state control unit 112 records a state of the network device 10. The state of the network device 10 may include, but not limited to, a normal state, a broadcast state and a loop state. The state indicates the operating phase of the network device 10. For example, the situation that the network device 10 is in the normal state represents that the network device 10 does not receive any broadcast frames, or the rate of broadcast frames received by the network device 10 does not exceed the broadcast threshold. The situation that the network device 10 is in the broadcast state represents that the rate of broadcast frames receives by the network device 10 exceeds the broadcast threshold and no loop is found. The situation that the network device 10 in the loop state represents that a loop is found by the network device 10.

The alerting unit 114 is utilized for issuing an alert if the loop checking unit 108 determines that a loop exists in the network environment. Example of the alerting unit 114 may include but not limited to a LED light bulb (for blinking) or a buzzer (for beeping).

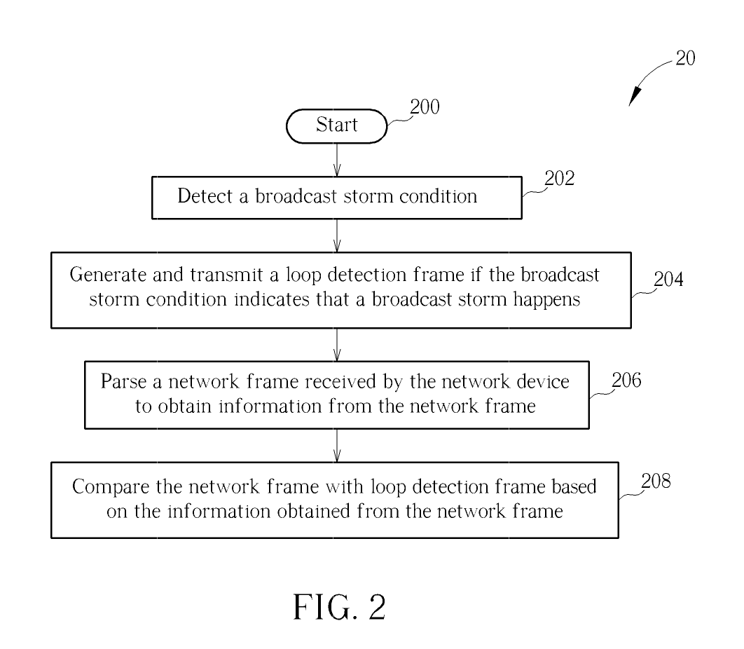

Please refer to FIG. 2, which is a flowchart diagram of a loop detection process 20 of the present invention. The loop detection process 20 is executed by the network device 10 and includes the following steps:

Step 200: Start.

Step 202: Detect a broadcast storm condition.

Step 204: Generate and transmit a loop detection frame if the broadcast storm condition indicates that a broadcast storm happens.

Step 206: Parse a network frame received by the network device to obtain information from the network frame.

Step 208: Compare the network frame with loop detection frame based on the information obtained from the network frame.

In the loop detection process 20, the broadcast frame detection unit 102 first monitors whether there is any broadcast frame received to detect a broadcast storm condition. If at least one broadcast frame is received, the broadcast frame detection unit 102 records the number of received broadcast frames, calculates the broadcast frame rate, and compares the broadcast frame rate with the broadcast threshold. If the broadcast frame rate exceeds the broadcast threshold, the broadcast frame detection unit 102 indicates that a broadcast storm happens. Conversely, if the broadcast frame rate does not exceed the broadcast threshold, the broadcast frame detection unit 102 determines that no broadcast storm happens, and keeps detecting a broadcast storm condition.

When the broadcast frame detection unit 102 indicates that the broadcast storm happens, the network device 10 further detects whether a loop exists. The network device 10 may initiate a loop detection frame timer. The loop checking unit 108 sets the loop detection frame count to be zero, and the loop detection frame generation unit 104 starts to generate and transmit a loop detection frame. The timestamp generation unit 110 attaches a timestamp identification code to the loop detection frame. When the loop detection frame is transmitted through the frame transmission units Port_t_1-Port_t_N, the network device 10 starts the loop detection frame timer.

If there is any network frame received before the loop detection frame timer elapses, the frame parser unit 106 parses the network frame to obtain required information for the loop checking unit 108 to determine if the network frame is originally transmitted from the network device 10, i.e., whether the module ID and the timestamp identification code of the network frame are the same as those of the transmitted loop detection frame.

If the network frame is originally transmitted from the network device 10 (i.e. the module ID and timestamp identification code of the network frame are the same as those of the transmitted loop detection frame), the loop checking unit 108 determines a loop exists in the network environment and stops the loop detection frame timer. Further, the loop checking unit 108 may also calculate the loop latency by comparing the timestamp identification code of the network frame and the timestamp counter in the timestamp generation unit 110. The loop checking unit 108 keeps the timestamp difference as the loop latency. The loop latency also helps to estimate the depth of the loop.

Additionally, the loop checking unit 108 may direct the alerting unit 114 to issue an alert for notifying users to take further actions to deal with the loop condition.

Otherwise, if the network frame is not originally transmitted from the network device 10 (i.e. the module ID and timestamp identification code of the network frame are different from those of the transmitted loop detection frame), the loop checking unit 108 ignores the network frame.

After the loop detection frame timer elapses or expires, if no loop detection frame is received, the loop checking unit 108 increases the loop detection frame count by 1. The loop detection frame generation unit 104 retransmits the loop detection frame with a new timestamp identification code, and restarts the loop detection frame timer.

When the loop detection frame count reaches a threshold, i.e. the number of the transmitted loop detection frame reaches the threshold but no transmitted loop detection frame is received, the loop checking unit 108 determines that no loop exists in the network environment. Instead, the broadcast frame detection unit 102 restarts detecting broadcast frame reception in the network device 10.

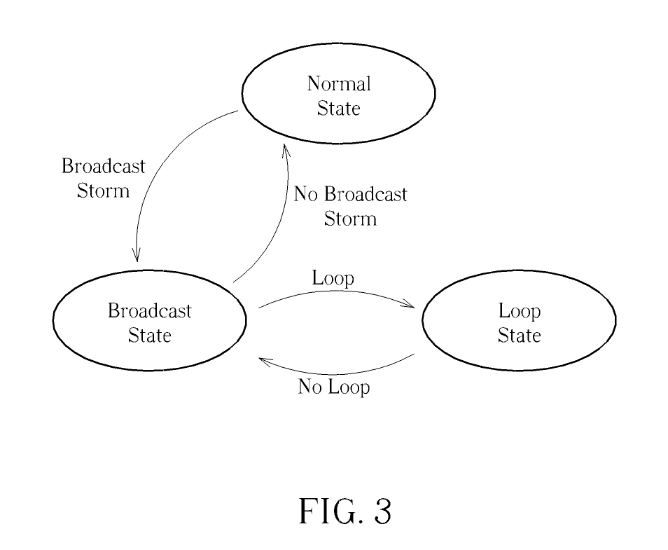

Please refer to FIG. 3, which is a state diagram of the network device 10 of the present invention. The state diagram is maintained by the state control unit 112. The initial state for the network device 10 is the normal state, which represents no broadcast frame is received by the network device 10, or the rate of broadcast frames received by the network device 10 does not exceed the broadcast threshold.

During the normal state, the broadcast frame detection unit 102 keeps detecting a broadcast storm condition. The state control unit 112 changes the state of the network device 10 from the normal state to the broadcast state if the broadcast storm condition detected by the broadcast frame detection unit 102 indicates the broadcast storm happens, i.e., the rate of broadcast frames received by the network device 10 exceeds the broadcast threshold.

During the broadcast state, the loop detection frame generation unit 104 generates and transmits loop detection frames, and the loop checking unit 108 compares network frames with the transmitted loop detection frames if there is any network frame received. Simultaneously, the broadcast frame detection unit 102 also keeps detecting a broadcast storm condition. The state control unit 112 changes the state of the network device 10 from the broadcast state to the loop state if the loop checking unit 108 determines a loop exists in the network environment, i.e. the received network frame is originally transmitted from the network device 10. On the other hand, the state control unit 112 changes the state of the network device 10 from the broadcast state to the normal state if the broadcast storm condition detected by the broadcast frame detection unit 102 indicates the broadcast storm does not happen, i.e. the rate of broadcast frames received by the network device 10 does not exceed the broadcast threshold.

During the loop state, the loop checking unit 108 directs the alerting unit 114 to issue an alert for notifying users to take further actions to deal with the loop condition. Also, the loop detection frame generation unit 104 keeps generating and transmitting loop detection frames, and the loop checking unit 108 keeps comparing network frames with the transmitted loop detection frames if there is any network frame received. The state control unit 112 changes the state of the network device 10 from the loop state to the broadcast state if the loop detection frame count reaches a threshold, i.e. the number of the transmitted loop detection frame reaches the threshold but no transmitted loop detection frame is received.

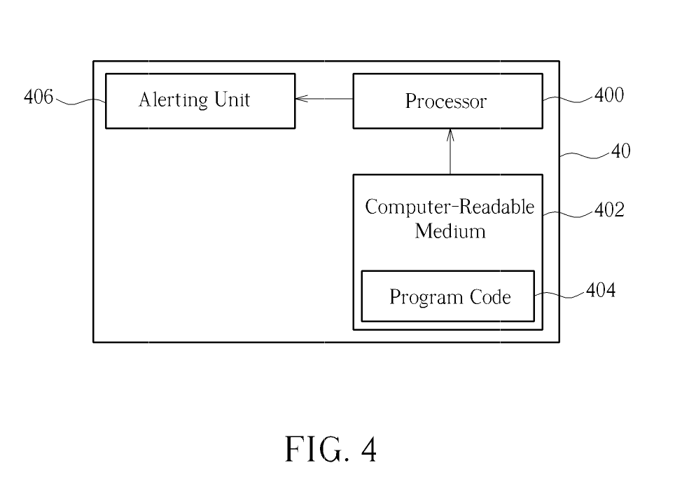

Alternatively, the aforementioned methods can be performed by a network device with a processor. Please refer to FIG. 4, which is a schematic diagram of a network device 40 according to a second embodiment of the present invention. The network device 40 includes a processor 400, a computer-readable medium 402, a program code 404 embedded in the computer-readable medium and an alerting unit 406. The processor 400 is capable of executing the program code 404. The computer-readable medium 402 can be any storage medium for storing the program code 404, such as hard disk drive, read-only memory (ROM), random-access memory (RAM) and universal serial bus (USB) flash drive, and can be recognized by the processor 400. The program code 404 instructs the processor 400 to perform the loop detection process 20. The processor 400 generates an interrupt signal if a loop exists in the network environment for exceptional actions, and then sends a control signal to the alerting unit 406 for issuing an alert.

The prior art network device needs to deploy additional components (e.g. source address detection unit and random number generation unit) for detecting a condition to start loop detection, or periodically broadcasting loop detection frames to detect a loop, causing waste of network resource and bandwidth. In comparison, the network device of the present invention detects a loop of the network environment by reusing existing component and does not need to periodically transmit loop detection frames, such that hardware cost and network bandwidth/resource can be saved.

To sum up, the network device and method for according to the embodiments of the present invention can provide loop detection of the network environment by reusing existing components without additional ones, such that the hardware cost and network bandwidth/resource occupation can be reduced.

Those skilled in the art will readily observe that numerous modifications and alterations of the device and method may be made while retaining the teachings of the present invention. Accordingly, the above disclosure should be construed as limited only by the metes and bounds of the appended claims.

What is claimed is:

1. A network device for loop detection in a network environment, comprising:
a broadcast frame detection unit, for detecting a broadcast storm condition;
a loop detection frame generation unit, for generating and transmitting a loop detection frame if the broadcast storm condition detected by the broadcast frame detection unit indicates a broadcast storm happens;
a frame parser unit, coupled to the broadcast frame detection unit, for parsing a network frame received by the network device to obtain an information from the network frame; and
a loop checking unit, coupled to the frame parser unit, for comparing the network frame with the loop detection frame based on the information obtained from the network frame.

2. The network device of claim 1, further comprising:
a timestamp generation unit, coupled to the loop detection frame generation unit, for generating a timestamp identification code and attaching the timestamp identification code to the loop detection frame, wherein the timestamp identification code of the loop detection frame is further registered for subsequent comparison to a timestamp identification code in the received network frame.

3. The network device of claim 1, wherein the broadcast frame detection unit determines that the broadcast storm happens if a number of broadcast frames received from the network environment during a period exceeds a threshold.

4. The network device of claim 1, wherein the loop checking unit determines that a loop exists in the network environment if the network frame is originally transmitted from the network device.

5. The network device of claim 4, wherein the loop checking unit determines the loop exists in the network environment if the timestamp identification code of the network frame is the same as the registered timestamp identification code of the transmitted loop detection frame and a module ID of the network frame is the same as a module ID of the transmitted loop detection frame.

6. The network device of claim 4, further comprising:
an alerting unit, for issuing an alert when the loop is determined to exist in the network environment.

7. The network device of claim 4, wherein a latency of the loop is obtained according to the information obtained from the network frame and the difference between the timestamp identification code of the network frame and a timestamp counter in the timestamp generation unit.

8. The network device of claim 1, further comprising:
a state control unit, coupled to the broadcast frame detection unit, the loop detection frame generation unit and the loop checking unit, for managing a state of the network device.

9. The network device of claim 8, wherein the state of the network device is changed to a broadcast state if the broadcast storm condition detected by the broadcast frame detection unit indicates the broadcast storm happens.

10. The network device of claim 8, wherein the state of the network device is changed to a loop state if the loop checking unit determines a loop exists in the network environment.

11. The network device of claim 10, wherein the state of the network device is changed to a broadcast state from the loop state if the loop checking unit determines no loop exists in the network environment.

12. The network device of claim 8, wherein the state of the network device is changed to a normal state if the broadcast storm condition detected by the broadcast frame detection unit indicates the broadcast storm does not happen.

13. A method for a network device to perform loop detection in a network environment, the method comprising:
detecting a broadcast storm condition;
generating and transmitting a loop detection frame if the broadcast storm condition indicates a broadcast storm happens;
parsing a network frame received by the network device to obtain an information from the network frame; and
comparing the network frame with the loop detection frame based on the information obtained from the network frame.

14. The method of claim 13, further comprising:
generating a timestamp identification code and attaching the timestamp identification code to the loop detection frame, wherein the timestamp identification code of the loop detection frame is further registered for subsequent comparison to a timestamp identification code in the received network frame.

15. The method of claim 13, wherein the broadcast storm is determined to happen if a number of broadcast frames received from the network environment during a period exceeds a threshold.

16. The method of claim 13, wherein a loop is determined to exist in the network environment if the network frame is originally transmitted from the network device.

17. The method of claim 16, wherein the loop is determined to exist in the network environment if the timestamp identification code of the network frame is the same as the registered timestamp identification code of the transmitted loop detection frame and a module ID of the network frame is the same as a module ID of the transmitted loop detection frame.

18. The method of claim 16, further comprising:
issuing an alert when the loop is determined to exist in the network environment.

19. The method of claim 16, wherein a latency of the loop is obtained according to the information obtained from the network frame and the difference between the timestamp identification code of the network frame and a timestamp counter in the timestamp generation unit.

20. The method of claim 13, further comprising:
managing a state of the network device.

21. The method of claim 20, wherein the state of the network device is changed to a broadcast state if the broadcast storm condition indicates the broadcast storm happens.

22. The method of claim 20, wherein the state of the network device is changed to a loop state if a loop is determined to exist in the network environment.

23. The method of claim 22, wherein the state of the network device is changed to a broadcast state from the loop state if no loop is determined to exist in the network environment.

24. The method of claim 20, wherein the state of the network device is changed to a normal state if the broadcast storm condition indicates the broadcast storm does not happen.

25. A network device for loop detection in a network environment, comprising:
a processor;
a computer-readable medium; and
a program code embedded in the computer-readable medium;
wherein the program code instructs the processor to execute the following steps:
detecting a broadcast storm condition;
generating and transmitting a loop detection frame if the broadcast storm condition indicates a broadcast storm happens;
parsing a network frame received by the network device to obtain an information from the network frame; and
comparing the network frame with the loop detection frame based on the information obtained from the network frame.

26. The network device of claim 25, wherein the program code further instructs the processor to execute the following steps:
generating an interrupt signal if a loop is determined to exist in the network environment; and
sending a control signal to an alerting unit for issuing an alert.
